(19) United States
(12) Patent Application Publication
(10) Pub. No.: US 2005/0255081 A1
(43) Pub. Date: Nov. 17, 2005

(54) Stabilizers for hydrolyzable organic binders

(76) Inventors: Kenneth Tseng, Lawrenceville, NJ (US); Scot Swan, King of Prussia, PA (US); David Mountz, Exton, PA (US); Mark Aubart, Malvern, PA (US); Michael Abrams, Philadelphia, PA (US); Gary Stephen Silverman JR., Chadds Ford, PA (US)

Correspondence Address: Thomas F. Roland, Esq.;Arkema Inc., 2000 Market St., Philadelphia, PA, 19103, US

(21) Appl. No.: 11/117,088

(22) Filed: Apr. 28, 2005

Related U.S. Application Data
(60) Provisional application No. 60/569,941, filed on May 11, 2004.

(51) Int. Cl. A01N 63/00

(52) U.S. Cl. 424/78.09

(57) ABSTRACT

The present invention relates to triorgano phosphites, triorgano amines, heteroaromatic nitrogen compounds, and carbodiimides used as stabilizers for hydrolyzable organic binders. The stabilizers help to prevent viscosity thickening of polymeric binders containing carboxylic ester groups. Without stabilization, the binders can rapidly thicken when exposed to moisture air. The stabilized organic binders of the invention are especially useful for formulating marine antifoulant coatings.

This application claims benefit under U.S.C. §119(e) of U.S. provisional application 60/569,941, filed May 11, 2004.

### FIELD OF THE INVENTION

The present invention relates to triorgano phosphites, triorgano amines, heteroaromatic nitrogen compounds, and carbodiimides used as stabilizers for hydrolyzable organic binders. The stabilizers help to prevent viscosity thickening of polymeric binders containing carboxylic ester groups. Without stabilization, the binders can thicken when exposed to moisture. The stabilized organic binders of the invention are especially useful for formulating marine antifoulant coatings.

### BACKGROUND OF THE INVENTION

Polymers containing hydrolyzable groups, especially hydrolyzable carboxylic ester groups, have been shown to exhibit excellent self-polishing performance in marine antifoulant coatings. One problem experienced with these coatings is poor shelf stability due to moisture exposure and incompatibility with added Zn compounds. Once exposed to moist air, the viscosity tends to increase rapidly, resulting in a thick mass. In addition, the moisture content of a variety of coating additives, such as cuprous oxide, organic booster biocides, other additives, and acidic co-binders, such as rosin acid, further contributes to poor shelf stability.

The prior art teaches that traces of water and acid are causes of stability problems in triorganotin antifoulant coatings. Protic functionality is primarily considered to be the cause of stability problems with silyl acrylate binders. Protic functionality is defined here as any molecule containing a positively polarized reactive proton. Examples are trace acid or water. Trace acid is defined here as hydrolyzed residual monomer and/or pendant acid groups on the polymer backbone resulting from polymer hydrolysis and/or polymerization of hydrolyzed monomer. Our screening tests confirm that trace acid indeed decreases the stability of silyl acrylate polymers containing hydrolyzable silyl carboxylate groups.

Two primary methods have been used to stabilize binders and antifoulant coating compositions against hydrolysis during storage. One involves neutralization of trace acid by a base to form a salt. Selected cationic pendant groups on the polymer backbone resulting from neutralization will not crosslink with metals found in a paint formulation. Residual salts formed in the reaction of a base with hydrolyzed residual monomer can also prevent acid-catalyzed polymer hydrolysis. Monoamine and quaternary ammonium compounds have been described for increasing the storage stability of antifoulant paints containing binders with organosilyl functional groups in WO 91/14743. The compounds inhibit paint gelation caused by using antifoulant agents that contain copper or zinc. Diterpene-containing amines are used as marine paint binder and biocide in U.S. Pat. No. 5,116,407.

U.S. Pat. No. 4,376,181 discloses the use of hindered phenols, such as 2,6-di-tert-butylphenol, to reduce the viscosity increase observed in the storage of antifoulant paints containing cuprous oxide and triorganotin-containing polymers.

Triazole, thiadiazole, and benzothiazole derivatives have been described in U.S. Pat. Nos. 5,773,508, and 5,439,511 as stabilizers of antifoulant paints containing unsaturated acid anhydrides. These derivatives prevent the increase in viscosity observed when the antifoulant paints contain copper compounds.

Another method of stabilization involves removal or binding of any water in the formulation. This is typically done with molecular sieves and desiccants.

One such method is to add an organic or inorganic dehydrating agent. U.S. Pat. Nos. 6,458,878; 6,172,132 and 6,110,990 describe the use of anhydrous gypsum (CaSO₄), synthetic zeolites such as molecular sieves, orthoesters such as methyl orthoformate and methyl orthoacetate, orthoboric esters, silicates, and isocyanates.

U.S. Pat. No. 4,187,211, describes the use of a relatively inert and water insoluble dehydrating agent in triorganotin antifoulant paints to inhibit the viscosity increase. In U.S. Pat. Nos. 5,342,437; 5,252,123; 5,232,493; 5,185,033; 5,112,397; and 5,098,473, natural and synthetic clays (e.g. bentonite) and desiccants (e.g. molecular sieves, alumina) were effective to increase storage stability by removing moisture in paints containing zinc pyrithione and cuprous oxide.

A problem with molecular sieves and most dessicants is that the binding of water is a reversible (equilibrium) process. Thus, while the majority of the water is bound, some amount is always available to the system for hydrolysis of the polymer binder.

Chelating agents have been used to stabilize antifoulant paints containing acrylic, polyester, or silyl resins. EP 1 033 392 describes the use of chelating agents such as beta-diketones, esters of acetoacetic acid, alpha-dioximes, bipyridyls, oximes, alkanolamines, glycols, salicylic acid and derivatives thereof, and organic acids. These chelating agents prevent the viscosity increase and deterioration of coating properties observed when copper antifoulant agents are added to the paint.

Each of the present approaches to the problem of poor storage stability have shortcomings related to incompatibility, volatility, poor efficiency, or some other problem. For example, hydroxylamines and tributyltin oxide, effective stabilizers for triorganotin polymers/paints, were found to be ineffective as stabilizers for silyl acrylate polymers.

Surprisingly, several other compounds have been found to be effective stabilizers for polymers containing hydrolyzable carboxylic acid groups. These novel stabilizers include triorgano phosphites, triorgano amines, heteroaromatic nitrogen compounds, isocyanates, and carbodiimides. These stabilizers are useful in stabilizing both the binder and formulations containing the binder, such as marine antifoulant coatings.

### SUMMARY OF THE INVENTION

An objective of this invention is to identify effective stabilizers for binder compositions containing polymers having hydrolyzable carboxylic ester groups.

It is a further objective to identify marine anti-fouling coating formulations using the novel stabilizers.

These objectives have been met by the present invention of a stabilized binder composition for use in an antifoulant coating comprising:
a) one or more hydrolyzable organic binders; and
b) 0.01 to 20 percent by weight of one or more stabilizers selected from the group consisting of triorgano phosphites, triorgano amines, heteroaromatic nitrogen compounds, carbodiimides, and mixtures thereof.

The objectives are also met by the present invention of an antifoulant coating composition comprising:
a) one or more hydrolyzable organic binders;
b) 0.01 to 20 percent by weight of one or more stabilizers selected from the group consisting of triorgano phosphites, triorgano amines, heteroaromatic nitrogen compounds, carbodiimides; and mixtures thereof;
c) an antifoulant

### DETAILED DESCRIPTION OF THE INVENTION

This invention discloses triorgano phosphites, triorgano amines, heteroaromatic nitrogen compounds, and carbodiimides as effective stabilizers to inhibit the viscosity increase of hydrolyzable organic binders and their formulated coatings, especially marine antifoulant paints and coatings.

By a “hydrolyzable binder”, as used herein, is meant that the copolymer binder may undergo hydrolysis to form an acid including but not limited to, —COOH, and other acid functional groups such as —SO₃H, —HₓPO₄. The hydrolysis may be catalyzed by the presence of metals found as common additives in coating compositions.

As used herein, the term “copolymer” includes polymers comprising two or more different monomeric units. The invention also includes mixtures of copolymers.

Preferably the hydrolyzable binder is an acrylic copolymer binder. Examples of acrylic monomers useful in the invention include, but are not limited to acrylic acids, esters of acrylic acids, acrylic amides, and acrylonitriles. It also includes alkacrylic derivatives, and especially methacrylic derivatives. Functional acrylic monomers are also included. Examples of useful acrylic monomers include, but are not limited to esters of acrylic acid such as methyl acrylate, ethyl acrylate, propyl acrylate, n-butyl acrylate, t-butyl acrylate, sec-butyl acrylate, 2-ethylhexyl acrylate, cyclohexyl acrylate, phenyl acrylate, n-octyl acrylate, 2-hydroxyethyl acrylate, hydroxy-n-propyl acrylate, hydroxy-1-propyl acrylate, glycidyl acrylate, 2-methoxyethyl acrylate, 2-methoxypropyl acrylate, methoxytriethyleneglycol acrylate, 2-ethoxyethyl acrylate, ethoxydiethyleneglycol acrylate and the esters of methacrylic acid such as methylmethacrylate, ethyl methacrylate, propyl methacrylate, n-butyl methacrylate, t-butyl methacrylate, sec-butyl methacrylate, 2-ethylhexyl methacrylate, cyclohexyl methacrylate, 2-hydroxyethyl methacrylate, glycidyl methacrylate, 2-methoxyethyl methacrylate, 2-methoxypropyl methacrylate, methoxytriethyleneglycol methacrylate, and 2-ethoxyethyl methacrylate, hydroxy-n-propyl(meth)acrylate, hydroxy-1-propyl methacrylate, phenoxyethyl methacrylate, butoxy ethyl methacrylate, isobornyl(meth)acrylate. Other useful ethylenically unsaturated monomers include neopentyl glycolmethylether propoxylate acrylate, poly(propylene glycol)methylether acrylate, ethoxydiethyleneglycol methacrylate, acrylic acid, methacrylic acid, 2-butoxyethyl acrylate, crotonic acid, di(ethylene glycol) 2-ethylhexyl ether acrylate, di(ethylene glycol)methyl ether methacrylate, 3,3-dimethyl acrylic acid, 2-(dimethylamino)ethyl acrylate, 2-(dimethylamino)ethyl methacrylate, ethylene glycol phenyl ether acrylate, ethylene glycol phenyl ether methacrylate, 2 (5H)-furanone, hydroxybutyl methacrylate, methyl-2 (5H)-furanone, methyl trans-3-methoxyacrylate, 2-(t-butylamino)ethyl methacrylate, tetrahydrofurfuryl acrylate, 3 tris-(trimethylsiloxy)silyl propyl methacrylate, tiglic acid, and trans-2-hexenoic acid.

The acrylic monomer(s) are copolymerized with one or more non-acrylic ethylenically unsaturated monomers. The properties of the copolymer can be tailored by the choice and ratio of comonomer(s). It is possible to adjust the hydrophilic or hydrophobic nature of the copolymer by choice of comonomer(s) used. Examples of monomers useful in forming the copolymer of the invention include, but are not limited to, vinyl esters such as vinyl acetate, vinyl propionate, vinyl butyrate, vinyl benzoate, maleic esters such as dimethyl maleate, diethyl maleate, di-n-propyl maleate, diisopropyl maleate, di-2-methoxyethyl maleate, fumaric esters such as dimethyl fumarate, diethyl fumarate, di-n-propyl fumarate, diisopropyl fumarate, styrene, vinyltoluene, alpha-methylstyrene, N,N-dimethyl acrylamide, N-t-butyl acrylamide, N-vinyl pyrrolidone, and acrylonitrile.

The acrylic binder of the invention may be a Cu and/or Zn acrylic polymer binder having the formula:

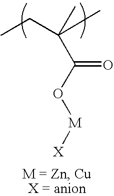

In a preferred embodiment, the acrylic polymer is an organosilyl (meth)acrylate polymer containing hydrolyzable organosilyl ester groups. Especially preferred are triarylsilyl(meth)acrylate-containing copolymers. Useful trialkylsilyl(meth)acrylates include trimethylsilyl(meth)acrylate, diphenylmethylsilyl(meth)acrylate, phenyldimethylsilyl(meth)acrylate, triisopropylsilyll(meth)acrylate and tributylsilyl(meth)acrylate.

The acrylic polymer binder of the present invention is prepared by polymerizing the acrylic monomer(s) with one or more ethylenically unsaturated non-acrylic monomers that are copolymerizable therewith. Specific monomers have been discovered to be useful in synthesizing terpolymers or higher polymers of the present invention to provide a polymer with improved properties such as film flexibility and crack resistance, while retaining acceptable water erodibility.

The random copolymer binder can be obtained by polymerizing the mixture of monomers in the presence of a free-radical olefinic polymerization initiator or catalyst using any of various synthetic procedures such as solution polymerization, bulk polymerization, emulsion polymerization, and/or suspension polymerization using methods well-known and widely used in the art. In preparing a coating composition from the copolymer, it is advantageous to dilute the copolymer with an organic solvent to obtain a polymer solution having a convenient viscosity. For this, it is desirable to employ the solution polymerization method or bulk polymerization method.

Examples of useful organic solvents include aromatic hydrocarbons such as xylene and toluene, aliphatic hydrocarbons such as hexane, cyclohexane, and heptane, esters such as ethyl acetate and butyl acetate, alcohols such as isopropyl alcohol and butyl alcohol, ethers such as dioxane and tetrahydrofuran, and ketones such as methyl ethyl ketone and methyl isobutyl ketone. The solvents are used either alone or in combination.

The desirable molecular weight of the acrylate copolymer is in the range of from 1,000 to 200,000, preferably from 10,000 to 150,000 in terms of weight-average molecular weight. Too low or too high molecular weight copolymers create difficulties in forming normal coating films. Too high molecular weights result in long, intertwined polymer chains that do not perform properly and result in viscous solutions that need to be thinned with solvent so that a single coating operation results in a thin film coating. Too low molecular weight polymers generally require multiple coating operations and provide films that may lack integrity and not perform properly. It is advantageous that the viscosity of the solution of the copolymer is in the range of 200 to 6,000 centipoise at 25° C., and generally less than 4,000 cps. To achieve this, it is desirable to regulate the solid content of the polymer solution to a value in the range of from 5 to 90% by weight, desirably from 15 to 85% by weight.

Four types of compounds have been identified as effective stabilizers of hydrolyzable organic polymer binders, and especially for sily(meth)acrylate polymers, and coatings. These compounds are (1) triorgano phosphites, (2) triorgano amines, (3) heteroaromatic amines (e.g. pyridine), and (4) carbodiimides (e.g. dicyclohexylcarbodiimide).

Triorgano phosphites of the invention have the formula (RO)₃P, wherein R is a C₂ to C₁₆ alkyl, a cycloalkyl, or an aryl or substituted aryl group. Examples of triorgano phosphites useful as stabilizers include, but are not limited to, triethylphosphite, tripropylphosphite, tributylphosphite, triphenylphosphite, trioctylphosphite, triisodecylphophite, triisopropylphosphite. Preferred triorgano phosphites are triethylphosphite, tripropylphosphite, tributylphosphite.

Triorganoamines of the invention have the formula R₃N wherein R is a C₂ to C₁₆ alkyl, a cycloalkyl, or an aryl or substituted aryl group. Examples of triorgano amines useful as stabilizers include, but are not limited to tripropylamine, tributylamine, triethylamine, triallylamine, trioctylamine, trisooctylamine, triphenylamine, and tridodecylamine. Preferred triorgano amines are tripropylamine, tributylamine, and triethylamine.

Heteroaromatic amines of the invention are amines containing a 5-6 membered ring containing a nitrogen atom. Examples of heteroaromatic amines useful as stabilizers include, but are not limited to pyridine, 1,2,4-triazole, 1,3,5-triazine. A preferred heteroaromatic amine is pyridine and its derivatives, including but not limited to vinyl pyridine, substituted pyridine, and 2-methylpyridine.

While not being bound by any particular theory, it is believed that the triorgano phosphites, triorgano amines, and heteroaromatic amines can act as P: or N: Lewis bases. The triorganophosphites can act both as a radical scavenger and as a base, while the triorgano amines or heteroaromatic nitrogen compounds can function strictly as bases—i.e. acid scavengers. Nitrogen compounds appear to be more effective than phosphites.

It was found that pyridine at 2 weight percent loading outperformed other nitrogen bases tested (Example 1). It is a very effective stabilizer for the silyl acrylate polymer, even in the presence of 3 wt % Zn Omadine (zinc pyrithione)—a worst-case composition.

Phosphites were found to be more effective than pyridine in stabilizing antifoulant paints containing high loading of cuprous oxide. Cuprous oxide is the cheapest biocide and pigment used in antifoulant paints, typically at 30-65 wt %.

In one preferred embodiment, a blend of phosphites and nitrogen bases (e.g. pyridine or alkylamines) are used as the stabilizer. Such a blend can act synergistically providing a solution to resin stability and compatibility with Zn or Cu biocides. Such an improvement in stability was seen in a combination of pyridine and triethylphosphite, in Example 9. In another embodiment, a non-pyridine amine and bulky phosphites or hindered amines (known as heat or light stabilizers) can be combined to provide synergistic stability.

Carbodiimides of the invention are those having the formula R—N═C═N—R, where R is the same or different and equal to a C₂ to C₁₆ alkyl, cycloalkyl, or aryl or substituted aryl. Examples of carbodiimides useful as stabilizers include, but are not limited to 1,3-dicyclohexylcarbodiimide; 1,3-bis(trimethylsilyl)carbodiimide; 1,3-di-p-tolylcarbodiimide, 1-(3-(dimethylaminopropyl)-3-ethylcarbodiimide methiodide; 1,3-di-t-butylcarbodiimide; 1,3-diisopropylcarbodiimide; Preferred carbodiimides are dicyclohexylcarbodiimides.

Carbodiimides act as dehydrating agents to stabilize the hydrolyzable polymer. Desiccants currently used in the art, such as sodium sulfate, molecular sieves, or clay, work by physically absorbing moisture. This is a reversible equilibrium process. Depending on the storage conditions (temperature and duration), physically absorbed water can be released back into the system leading to hydrolysis. Carbodiimides chemically react with moisture. The chemical reaction with moisture is irreversible and allows the composition to maintain a high degree of stability over a long period of time.

An example of a carbodiimide useful in the present invention is dicyclohexylcarbodiimide. Upon reaction with water, the byproduct is dicyclohexyl urea. This nitrogen-containing product can then serve to further enhance the stability of the binder/paint.

The stabilizers of the invention can be combined with polymeric binders by means known in the art. One or more of the stabilizers is combined at from 0.01 to 20 weight percent based on the polymer solids, preferably from 0.1 to 8.0 weight percent. The stabilizer may be mixed with a solution of the binder or directly into the final coating formulation. Some of the stabilizers may also be incorporated into or onto the polymer backbone via free radical polymerization or by another suitable method. The incorporation of the stabilizers into/onto the polymer helps to minimize the leaching out of the stabilizer from the coating composition.

The stabilizer may be used in conjunction with one or more stabilizers known in the art. Other additives in the coating formulation may include, but are not limited to, one or more co-binders and/or additives, such as rosin or functionalized rosin (e.g. metal rosinates). Additional additives include pigments, organic dyes, drying agents, plasticizers, dispersing agents, fillers, thixotropic agents, biocides (e.g. Cu₂O), and organic co-biocides, as known in the art.

The stabilized binder compositions may be used to fabricate self-polishing marine antifoulant paints. In general, the erosion rate of a self-polishing marine antifoulant paint is considered to be a function of the amount of hydrolyzable monomer in the polymer. Indeed, U.S. Pat. No. 4,593,055, which discloses and claims seawater erodible silyl acrylate copolymers, teaches at Column 5, lines 43 et seq. that the superior control of the erosion rate relies on chemically tailoring the polymer so that it is selectively weakened at certain points pendant to the polymer chain at the paint/water interface. These weak links are slowly attacked by seawater allowing the polymer to gradually become seawater soluble or seawater swellable. This weakens the hydrolyzed surface polymer film to such an extent that moving seawater is able to wash off this layer and thus expose a fresh surface.

The toxicant used as an antifoulant in the coating composition of the present invention may be any of a wide range of conventionally known toxicants. The known toxicants are roughly divided into inorganic compounds, metal-containing organic compounds, and metal-free organic compounds.

Examples of inorganic toxicant compounds include copper compounds such as cuprous oxide, copper powder, copper thiocyanate, copper carbonate, copper chloride, and copper sulfate, and zinc and nickel compounds such as zinc sulfate, zinc oxide, nickel sulfate, and copper-nickel alloys.

Examples of metal-containing organic toxicant compounds include organocopper compounds, organonickel compounds, and organozinc compounds. Examples of organocopper compounds include oxine copper, copper nonylphenolsulfonate, copper bis(ethylenediamine)bis(dodecylbenzenesulfonate), copper acetate, copper naphthenate, and copper bis(pentachlorophenolate). Examples of organonickel compounds include nickel acetate and nickel dimethyldithiocarbamate. Examples of organozinc compounds include zinc acetate, zinc carbamate, zinc dimethyldithiocarbamate, zinc pyrithione, and zinc ethylenebis (dithiocarbamate).

Examples of metal-free organic toxicant compounds include N-trihalomethylthiophtalimides, dithiocarbamic acids, N-arylmaleimides, 3-(substituted amino)-1,3-thiazolidine-2,4-diones, dithiocyano compounds, triazine compounds, and others.

Examples of N-trihalomethylthiophthalimide toxicants include N-trichloromethylthiophthalimide and N-fluorodichloromethylthiophthalimide. Examples of dithiocarbamic toxicants include bis(dimethylthiocarbamoyl)disulfide, ammonium N-methyldithiocarbamate, and ammonium ethylenebis(dithiocarbamate).

Examples of arylmaleimide toxicants include N-(2,4,6-trichlorophenyl) maleimide, N-4-tolylmaleimide, N-3-chlorophenylmaleimide, N-(4-n-butylphenyl) maleimide, and N-anilinophenyl)maleimide.

Examples of 3-(substituted amino)-1,3-thiazolidine-2,4-dione toxicants include 3 benzylideneamino-1,3 thiazolidine-2,4-dione, 3-4(methylbenzylideneamino), 1,3-thiazolidine-2,4-dione, 3-(2-hydroxybenzylideneamino-1,3-thiazolidine-2,4-thiazolidine-2,4-dione, 3-(4-dichlorobenzylideneamino)-1,3-thiazolidine-2,4-dione and 3-(2,4-dichlorobenzylideneamino-1,3-thiazolidine-2,4-dione.

Examples of dithiocyano toxicant compounds include dithiocyanomethane, dithiocyanoethane, and 2,5-dithiocyanothiophene. Examples of the triazine compounds include 2-methylthio-4-t-butylamino-6-cyclo-propylamino-s-triazine.

Other examples of metal-free organic toxicant compounds include 2,4,5,6-tetrachloroisophthalonitrile, N,N-dimethyldichlorophenylurea, 4,5-dichloro-2-n-octyl-4-isothiazoline-3-one, N,N-dimethyl-N′-phenyl-(N-fluorodichloromethylthio) sulfamide, tetramethylthiuram disulfide, 3-iodo-2-propylbutyl carbamate, 2-(methoxycarbonylamino)benzimidazole, 2,3,5,6-tetrachloro-4-(methylsulfonyl) pyridine, 4-bromo-2-(4-chlorophenyl)-5-(trifluromethyl)-1H-pyrrole-3-carbonitrile, 3-benzo[b]thien-2-yl-5,6-dihydro-1,4,2-oxathiazine 4-oxide, dichloro-N-[(dimethylamino)sulfonyl]fluoro-N-(p-tolyl)methanesulfenamide, dichlofluanide, and diiodomethyl-p-tolyl sulfone.

One or more toxicants, which may be selected from the foregoing toxicants, can be employed in the antifoulant coating composition. The toxicant is used in an amount from 0.1 to 80% by weight, preferably from 1 to 60% by weight of the coating composition. Too low toxicant levels do not produce an antifoulant effect, while too large a toxicant level can result in the formation of a coating film which is liable to develop defects such as cracking and peeling, thereby, becoming less effective.

The stabilized coating composition of the present invention may be used to coat structures exposed to marine, freshwater, or brackish water. They may also be used to coat structures exposed to high humidity, for which a slowly eroding coating may be useful, such as preventing a build-up of moss or other organisms. These structures include, but are not limited to ships, boats, docks, breakwaters, and pier supports.

### EXAMPLES

In all Examples, percentages are weight percent unless otherwise indicated.

An accelerated storage stability test was run according to the following procedure: 1) Fill a small paint can (½ to 1 pint size) with a liquid test sample and leave at least ¼″ air space on top. 2) Record the initial viscosity, and seal the can properly with a lid. 3) Place the can into an oven at 55° C. 4) Record the viscosity weekly and inspect the paint consistency. 5) Terminate the test if the sample develops lumps or gels before 8 weeks. 6) Continue the test for 8 weeks. 7) Judge based on a Pass/Fail criteria of no skinning or gelling. All viscosity measurements were done at 25° C. using a Brookfield RVT viscometer. Note that an asterisk in the tables below indicates that the sample gelled and a measurement of the viscosity was not possible. Under these conditions, a tributyltin copolymer passes after 8 weeks at 55° C. This increase in viscosity for the tributyltin copolymer corresponds to 2 years of shelf life at room temperature.

### Example 1

A sample of poly(diphenylmethylsilyl methacrylate -co-methyl methacrylate) in 50 wt % xylene solution was combined with each of the following listed stabilizers. The percentage of stabilizer and other additives is based on the wt charged to a 50% binder solution. The combined sample was then placed on a paint shaker for 20 minutes, and evaluated using the described accelerated test. The results are shown in Table 1.
1.1 (Comparative) Polymer with no stabilizer.
1.2 Polymer with 5% Triethyl phosphite.
1.3 (Comparative) Polymer with 5% bistributyltin oxide (TBTO).
1.4 (Comparative) Polymer with 5% butylated hydroxy toluene (BHT).
1.5 (Comparative) Polymer with 5% hydroquinone.
1.6 (Comparative) Polymer with 5% Isopropyl alcohol (IPA).

1.7 (Comparative) Polymer with 5% ethyl acetate.

TABLE 1
Viscosity Ratio (Relative to Initial Viscosity) per Time (Weeks)

| | Initial | | | | | | | | | |
|---|---|---|---|---|---|---|---|---|---|---|
| ID# | Viscosity | 1 | 2 | 3 | 4 | 5 | 6 | 7 | 8 | 9 |
| 1.1 | 12320 | 1.7 | 2.2 | 3.3 | 3.3 | 3.3 | 3.3 | * | * | * |
| 1.2 | 4000 | 1.0 | 1.1 | 1.2 | 1.2 | 1.3 | 1.2 | 1.3 | 1.1 | 1.4 |
| 1.3 | 2700 | 1.3 | 1.5 | 1.9 | 2.3 | 3.0 | 4.1 | 6.0 | 6.2 | 9.7 |
| 1.4 | 9000 | 2.0 | 4.4 | 4.4 | 4.4 | 4.4 | * | * | * | * |
| 1.5 | 14600 | 2.7 | 2.7 | * | * | * | * | * | * | * |
| 1.6 | Gel | * | * | * | * | * | * | * | * | * |
| 1.7 | 2850 | 1.9 | 3.7 | 3.5 | 5.6 | 7.9 | 6.8 | 12.1 | 6.9 | 14.0 |

Conclusion: Triethylphosphite (ID# 1.2) stands out as the best stabilizer in this test group.

### Example 2

The following samples were prepared and tested in the same manner as in Example 1. Results are shown in Table 2.
2.1 (Comparative) Polymer with no stabilizer.
2.2 Polymer with 2% tributyl phosphite (TBP).
2.3 Polymer with 2% triphenyl phosphite.
2.4 Polymer with 2% triethyl phosphite (TEP).
2.5 Polymer with 1% triethyl phosphite.
2.6 (Comparative) Polymer with 5% triethyl borate.
2.7 (Comparative) Polymer with 5% diphenylmethylsiloxane.
2.8 (Comparative) Polymer with 5% triphenyl silanol.
2.9 (Comparative) Polymer with 5% ethyl acetonate.
2.10 (Comparative) Polymer with 5% zinc oxide.
2.11 (Comparative) Polymer with 5% titanium isopropoxide.

2.12 (Comparative) Polymer with 5% zinc pyrithione.

TABLE 2
Viscosity Ratio (Relative to Initial Viscosity) per Time (Weeks )

| | Initial | | | | | | | | |
|---|---|---|---|---|---|---|---|---|---|
| ID# | Viscosity | 1 | 2 | 3 | 4 | 5 | 6 | 7 | 8 |
| 2.1 | 8140 | 1.7 | 1.8 | 3.3 | 4.9 | * | * | * | * |
| 2.2 | 5450 | 0.9 | 1.0 | 1.2 | 1.2 | 1.4 | 1.5 | 1.9 | 1.9 |
| 2.3 | 7220 | 1.6 | 2.3 | 4.9 | 5.5 | 5.5 | * | * | * |
| 2.4 | 4640 | 0.9 | 1.1 | 1.5 | 2.0 | 1.9 | 2.7 | 2.7 | 4.0 |
| 2.5 | 5600 | 1.0 | 1.1 | 1.3 | 1.4 | 1.6 | 1.9 | 2.5 | 2.9 |
| 2.6 | 5900 | 4.6 | 6.8 | 6.8 | * | * | * | * | * |
| 2.7 | 9050 | 2.1 | 2.6 | 3.7 | 4.4 | 4.4 | * | * | * |
| 2.8 | 5930 | 0.9 | 2.3 | 3.0 | 4.7 | 4.4 | 6.7 | 6.7 | 6.7 |
| 2.9 | 3000 | 1.7 | 2.4 | 3.2 | 5.6 | 6.7 | 9.2 | 11.2 | 11.4 |
| 2.10 | Gelled | * | * | * | * | * | * | * | * |
| 2.11 | Gelled | * | * | * | * | * | * | * | * |
| 2.12 | 2800 | 1.5 | 2.4 | 3.1 | 3.6 | 4.5 | 5.8 | 7.2 | 9.1 |

Conclusion: Without a stabilizer, the polymer gelled in 4 weeks at 55° C. Tributylphosphite and triethylphosphite are the two best stabilizers in this group.

### Example 3

The following samples were prepared and tested in the same manner as in Example 1, with the modification that the polymer used was poly(triphenylsilyl methacrylate-co-methyl methacrylate) in 50 wt % xylene solution instead of poly(diphenylmethylsilyl methacrylate -co-methyl methacrylate) in 50 wt % xylene solution. The results are shown in Table 3.
3.1 (Comparative) Polymer with no stabilizer.
3.2 Polymer with 2% tributyl phosphite.
3.3 Polymer with 2% triethyl phosphite.
3.4 Polymer with 5% tripropylamine.

3.5 (Comparative) Polymer with 5% zinc pyrithione(ZnPT).

TABLE 3
Viscosity Ratio (Relative to Initial Viscosity) per Time (Weeks)

| | Initial | | | | | | | | |
|---|---|---|---|---|---|---|---|---|---|
| ID# | Viscosity | 1 | 2 | 3 | 4 | 5 | 6 | 7 | 8 |
| 3.1 | 795 | 1.7 | 2.1 | 3.1 | 4.3 | 5.3 | 6.8 | 8.9 | 9.8 |
| 3.2 | 687 | 1.3 | 1.4 | 1.6 | 1.8 | 2.1 | 2.3 | 2.6 | 2.9 |
| 3.3 | 625 | 1.2 | 1.2 | 1.3 | 1.4 | 1.6 | 1.6 | 1.8 | 1.9 |
| 3.4 | 544 | 1.2 | 1.2 | 1.4 | 1.7 | 2.0 | 2.2 | 2.6 | 2.9 |
| 3.5 | 882 | 1.7 | 1.9 | 2.4 | 3.3 | 3.8 | 3.9 | 4.7 | 5.1 |

Conclusion: The control did not gel after 8 weeks, but the viscosity had increased by 10 times. The best performers in this group are triethylphosphite, tributylphosphite, and tripropylamine.

### Example 4

The following samples were prepared and tested in the same manner as Example 3. Results are shown in Table 4.
4.1 (Comparative) Polymer with no stabilizer.
4.2 Polymer with 2% triphenyl phosphite.
4.3 Polymer with 2% tributyl phosphite.
4.4 Polymer with 2% tripropylamine.
4.5 (Comparative) Polymer with 2% pyrrolidine.
4.6 (Comparative) Polymer with 2% urea.

4.6 Polymer with 2% pyridine.

TABLE 4
Viscosity Ratio (Relative to Initial Viscosity) per Time (Weeks)

| | Initial | | | | | | | | |
|---|---|---|---|---|---|---|---|---|---|
| ID# | Viscosity | 1 | 2 | 3 | 4 | 5 | 6 | 7 | 8 |
| 4.1 | 855 | 2.2 | 2.5 | 4.4 | 5.0 | 6.5 | 11.3 | 9.0 | 9.3 |
| 4.2 | 840 | 1.9 | 2.5 | 3.3 | 3.6 | 3.3 | 6.6 | 5.4 | 5.9 |
| 4.3 | 830 | 1.3 | 1.5 | 1.5 | 1.6 | 1.9 | 2.9 | 2.3 | 2.6 |
| 4.4 | 695 | 1.3 | 1.6 | 1.9 | 2.4 | 3.0 | 3.5 | 4.1 | 5.0 |
| 4.5 | 1748 | 12.4 | 19.8 | * | * | * | * | * | * |
| 4.6 | 972 | 1.9 | 2.5 | 3.3 | 3.6 | 4.1 | 4.3 | 5.6 | 5.8 |
| 4.7 | 645 | 1.1 | 1.2 | 1.3 | 1.3 | 1.5 | 1.5 | 1.6 | 1.8 |

Conclusion: Pyridine is the best performer in this group, followed by tributylphosphite. Triphenylphospite, tripropylamine, and urea also exhibit better performance than the control.

### Example 5

The following samples were prepared and tested in the same manner as in Example 3. Results are shown in Table 5.
5.1 (Comparative) Polymer with no stabilizer.
5.2 (Comparative) Polymer with 2% zinc oxide.
5.3 (Comparative) Polymer with 2% IPA.

5.4 Polymer with 2% triethylamine

TABLE 5
Viscosity Ratio (Relative to Initial Viscosity) per Time (Weeks)

| | Initial | | | | | | | | |
|---|---|---|---|---|---|---|---|---|---|
| ID# | Viscosity | 1 | 2 | 3 | 4 | 5 | 6 | 7 | 8 |
| 5.1 | 3707 | 1.8 | 2.1 | 2.4 | 2.9 | 3.3 | 3.7 | 4.1 | 5.5 |
| 5.2 | 3958 | 1.5 | 2.3 | 2.6 | 3.1 | 4.0 | 4.7 | 5.6 | 5.5 |
| 5.3 | 2050 | 2.3 | 5.6 | 10.9 | * | * | * | * | * |
| 5.4 | 2768 | 1.1 | 1.4 | 1.6 | 1.7 | 1.8 | 2.1 | 2.7 | 3.3 |

Conclusion: Note that the initial viscosity of the control had increased from 795 cps (Example 3) to 3707 cps - an indication of moist air exposure during storage and handling. In this group, the triethylamine mixture showed improvement over the control.

### Example 6

The following samples were prepared and tested in the same manner as in Example 3. Results are shown in Table 6.
6.1 (Comparative) Polymer with no stabilizer.
6.2 Polymer with 1.5% pyridine and 3% ZnPT.
6.3 Polymer with 1.0% pyridine and 3% ZnPT.
6.4 Polymer with 0.5% pyridine and 3% ZnPT.
6.5 Polymer with 0.9% pyridine.
6.6 Polymer with 1.0% pyridine and 3% ZINEB.
6.7 Polymer with 1.0% 2-vinyl pyridine.
6.8 Polymer with 2% 1-methyl-2-pyrrolidinone.

6.9 Polymer with 0.9%1-methyl-2- pyrrolidinone.

TABLE 6
Viscosity Ratio (Relative to Initial Viscosity) per Time (Weeks)

| | Initial | | | | | | | |
|---|---|---|---|---|---|---|---|---|
| ID# | viscosity | 1 | 2 | 3 | 4 | 5 | 7 | 8 |
| 6.1 | 4500 | 1.6 | 1.9 | 3.5 | 4.0 | 4.7 | 6.7 | 8.9 |
| 6.2 | 3600 | 1.0 | 1.1 | 1.1 | 1.4 | 1.6 | 2.0 | 2.1 |
| 6.3 | 3800 | 1.1 | 1.4 | 1.4 | 1.5 | 1.6 | 2.3 | 2.2 |
| 6.4 | 3770 | 1.1 | 1.5 | 1.5 | 1.6 | 2.0 | 2.9 | 3.0 |
| 6.5 | 3270 | 1.3 | 1.6 | 1.8 | 2.0 | 2.4 | 3.0 | 3.0 |
| 6.6 | 3760 | 1.3 | 1.4 | 1.5 | 1.7 | 2.0 | 2.9 | 3.2 |
| 6.7 | 3440 | 1.3 | 1.3 | 1.5 | 1.7 | 2.0 | 2.7 | 4.3 |
| 6.8 | 2750 | 1.2 | 1.3 | 1.3 | 1.5 | 1.7 | 2.6 | 2.7 |
| 6.9 | 3300 | 1.3 | 1.4 | 1.7 | 1.6 | 2.3 | 3.0 | 3.6 |

Conclusion: Pyridine and its derivatives are effective stabilizers. The results showed that pyridine stabilized polymers are compatible with Zn-based biocides (ZnPT and Zineb) at 3 wt %.

### Example 7

The following samples were prepared and tested in the same manner as in Example 3. Results are shown in Table 7.
7.1 (Comparative) Polymer with no stabilizer.
7.2 Polymer with 2% diethylhydroxylamine and 3% ZnPT.
7.3 Polymer with 2% imidazole and 3% ZnPT.
7.4 Polymer with 2% 1-methylimidazole and 3% ZnPT.

7.5 (Comparative) Polymer with 2% diethanolamine and 3% ZnPT.

TABLE 7
Viscosity Ratio (Relative to Initial Viscosity) per Time (Weeks)

| | Initial | | | | | | | | |
|---|---|---|---|---|---|---|---|---|---|
| ID# | Viscosity | 1 | 2 | 3 | 4 | 5 | 6 | 7 | 8 |
| 7.1 | 5750 | 1.2 | — | 1.8 | 1.8 | 1.9 | — | 2.5 | 2.7 |
| 7.2 | 3575 | 11.2 | — | 11.2 | 11.2 | 11.2 | — | 11.2 | 11.2 |
| 7.3 | 4938 | 2.0 | — | 2.5 | 2.7 | 4.3 | — | 6.0 | 4.1 |
| 7.4 | 3895 | 1.2 | — | 1.4 | 1.9 | 2.2 | — | 2.5 | 2.7 |
| 7.5 | 9213 | 1.1 | — | 1.9 | 1.6 | 1.9 | — | 2.4 | 2.1 |

Conclusion: Note that the initial viscosity of control has gone up to 5750 cps from 795 cps in Example 3 - an indication of poor storage stability of unstabilized polymer. All of these tests were carried out in the presence of 3% ZnPT to ensure stabilizer additives can overcome the incompatibility of Zn compounds.

### Example 8

The following samples were prepared and tested in the same manner as in Example 3. Results are shown in Table 8.
8.1 (Comparative) Polymer with no stabilizer.
8.2 Polymer with 0.9% pyridine. (Comparative).
8.3 (Comparative) Polymer with 3% Cu₂O, unstabilized.
8.4 (Comparative) Polymer with 3% Cu₂O and 0.9% pyridine.
8.5 (Comparative) Polymer with 3% ZnPT and 0.9% pyridine.
8.6 (Comparative) Polymer with 2% benzoic acid, unstabilized.

8.7 (Comparative) Polymer with 2% benzoic acid, unstabilized.

TABLE 8
Viscosity Ratio (Relative to Initial Viscosity) per Time (Weeks)

| | Initial | | | | | | | | |
|---|---|---|---|---|---|---|---|---|---|
| ID# | Viscosity | 1 | 2 | 3 | 4 | 5 | 6 | 7 | 8 |
| 8.1 | 13000 | — | 1.2 | 0.9 | 1.0 | 1.1 | 0.9 | 0.8 | 0.9 |
| 8.2 | 1530 | — | 1.2 | 1.3 | 1.5 | 1.5 | 1.4 | 1.3 | 1.6 |
| 8.3 | 4800 | — | 1.2 | 1.2 | 1.1 | 1.8 | 1.2 | 1.2 | 1.2 |
| 8.4 | 5550 | — | 1.4 | 1.1 | 1.3 | 1.2 | 1.2 | 1.3 | 1.5 |
| 8.5 | 2160 | — | 10.3 | 4.3 | 6.2 | 5.9 | 4.9 | 7.8 | 20.7 |
| 8.6 | 1930 | — | 1.9 | 2.9 | 4.4 | 4.4 | 4.8 | 4.8 | 5.7 |
| 8.7 | 3580 | — | 2.0 | 2.1 | 2.3 | 2.6 | 3.3 | 3.9 | 5.3 |

Conclusion: The initial viscosity of unstabilized polymer (8.1) started at 13,000 cps (increased from 3500 cps) - an indication of significant moist air exposure during storage and handling. As a result, there was no significant viscosity increase after 8 weeks; however, the starting viscosity is unacceptable.

### Example 9

The following samples were prepared and tested in the same manner as in Example 3. Results are shown in Table 9.
9.1 Polymer with 0.9% pyridine.
9.2 Polymer with 0.9% pyridine and 50% Cu₂O.
0.3 Polymer with 2.0% pyridine and 50% Cu₂O.
9.4 Polymer with 0.9% pyridine and 3% ZnPT in a tin can.
9.5 Polymer with 0.9% pyridine and 3% ZnPT in a glass bottle.
9.6 Polymer with 0.9% pyridine and 3% zinc oxide.
9.7 Polymer with 0.9% pyridine and 50% Cu₂O and 2% TBP
9.8 Polymer with 50% Cu₂O and 2% TBP.
9.9 Polymer with 50% Cu₂O and 2% TEP.
9.10 Polymer with 0.9% pyridine and 50% Cu₂O and 2% TEP.

9.11 Polymer with 0.9% pyridine and 2% TBP and 3% zinc omadine.

TABLE 9
Viscosity Ratio (Relative to Initial Viscosity) per Time (Weeks)

| | Initial | | | | | | | | |
|---|---|---|---|---|---|---|---|---|---|
| ID# | Visc. | 1 | 2 | 3 | 4 | 5 | 6 | 7 | 8 |
| 9.1 | 2150 | 1.0 | 0.9 | 0.9 | 1.1 | 1.3 | 1.0 | 1.2 | 1.1 |
| 9.2 | 9950 | * | * | * | * | * | * | * | * |
| 9.3 | 36700 | * | * | * | * | * | * | * | * |
| 9.4 | 2280 | 1.0 | 1.0 | 0.9 | 1.2 | 1.4 | 1.0 | 1.2 | 1.2 |
| 9.5 | 2378 | 1.2 | 1.2 | 1.3 | 1.3 | 1.8 | 1.5 | 1.9 | 2.0 |
| 9.6 | 3490 | 4.6 | 5.8 | 6.8 | 10.7 | 11.5 | 13.8 | 16.7 | * |
| 9.7 | 8400 | 1.4 | 0.7 | 22.0 | * | * | * | * | * |
| 9.8 | 10300 | 3.6 | 2.7 | 2.5 | 6.6 | 7.8 | * | * | * |
| 9.9 | 9960 | 1.3 | 1.0 | 1.4 | 2.1 | 8.0 | * | * | * |
| 9.0 | 9480 | 0.4 | 0.3 | 2.5 | * | * | * | * | * |
| 9.1 | 2055 | 1.2 | 1.3 | 1.9 | 6.7 | * | * | * | * |

Conclusion: The results clearly indicate pyridine stabilized polymer (9.1) is very stable; however, while the pyridine-stabilized polymer is compatible with ZnPT (9.4 & 9.5), it is not with Cu₂O.

### Example 10

The following samples were prepared and tested in the same manner as in Example 3. Results are shown in Table 10.
10.1 (Comparative) Polymer with 50% Cu₂O.
10.2 Polymer with 50% Cu₂O and 5% 1,3-dicyclohexylcarbodiimide ().
10.3 (Comparative) Polymer with 50% Cu₂O and 5% sodium oxalate.
10.4 (Comparative) Polymer with 50% Cu₂O and 5% ammonium acetate.
10.5 (Comparative) Polymer with 50% Cu₂O and 5% magnesium sulfate.
10.6 (Comparative) Polymer with 50% Cu₂O and 5% sodium sulfate.
10.7 (Comparative) Polymer with 50% Cu₂O and 5% calcium chloride.
10.8 (Comparative) Polymer with 50% Cu₂O and 5% dodecyclsulfate sodium salt.

10.9 (Comparative) Polymer with 50% Cu₂O and 5% molecular sieve (granules).

TABLE 10
Viscosity Ratio (Relative to Initial Viscosity) per Time (Weeks)

| | Initial | | | | | | | | | |
|---|---|---|---|---|---|---|---|---|---|---|
| ID# | Visc. | 1 | 2 | 3 | 4 | 5 | 6 | 7 | 8 | 9 |

| | | | | | | | | | | |
|---|---|---|---|---|---|---|---|---|---|---|
| 10.1 | 9850 | 2.5 | 2.8 | 4.6 | 4.2 | 6.6 | * | * | * | * |
| 10.2 | 6575 | 1.4 | 1.3 | 2.0 | 1.4 | 1.9 | 2.1 | 2.0 | 2.2 | 2.3 |
| 10.3 | 13950 | 2.2 | 3.1 | 5.7 | * | * | * | * | * | * |
| 10.4 | 60400 | * | * | * | * | * | * | * | * | * |
| 10.5 | 13760 | 3.0 | 4.5 | 5.8 | * | * | * | * | * | * |
| 10.6 | 11315 | 2.4 | 3.3 | 6.1 | 3.9 | 6.2 | * | * | * | * |
| 10.7 | 14400 | 2.1 | 3.5 | 5.5 | * | * | * | * | * | * |
| 10.8 | 26900 | 3.7 | * | * | * | * | * | * | * | * |
| 10.9 | 15200 | 1.9 | 2.6 | 3.8 | * | * | * | * | * | * |

Conclusion: Clearly, 1,3-dicyclohexylcarbodiimide stands out as an effective stabilizer for Cu₂O containing paint compared to other candidates.

### Example 11

The following samples were prepared and tested in the same manner as in Example 3. Results are shown in Table 11.
11.1 (Comparative) Polymer with 50% Cu₂O and 2% TEP.
11.2 (Comparative) Polymer with 50% Cu₂O, 3% isophorone diisocyanate and 3% zinc oxide.

11.3 Polymer with 50% Cu₂O, 3% dicyclohexylcarbodiimide and 3% zinc oxide.

TABLE 11
Viscosity Ratio (Relative to Initial Viscosity) per Time (Weeks)

| | Initial | | | | | | | | |
|---|---|---|---|---|---|---|---|---|---|
| ID# | Viscosity | 1 | 2 | 3 | 4 | 5 | 6 | 7 | 8 |
| 11.1 | 23800 | * | * | * | * | * | * | * | * |
| 11.2 | 10100 | 2.5 | 2.1 | 2.1 | 2.2 | 2.3 | 2.5 | 2.5 | 3.2 |
| 11.3 | 19400 | 0.9 | 1.0 | 0.8 | 1.2 | 1.4 | 1.4 | 1.6 | 1.8 |

Conclusion: The stabilizing effect of dicyclohexyl carbodiimide is further confirmed with50% Cu₂O, and 3% zinc oxide (11.3).

### Example 12

The following samples were prepared and tested in the same manner as in Example 3. Results are shown in Table 12.
12.1 (Comparative) Polymer with 5% isophorone diisocyanate.

12.2 Polymer with 5% 1,3-dicyclohexylcarbodiimide.

TABLE 12
Viscosity Ratio (Relative to Initial Viscosity) per Time (Weeks)

| | Initial | | | | | | | | |
|---|---|---|---|---|---|---|---|---|---|
| ID# | Viscosity | 1 | 2 | 3 | 4 | 5 | 6 | 7 | 8 |
| 12.1 | 2820 | 1.1 | 1.3 | 1.3 | 1.2 | 1.5 | 1.8 | 1.5 | 1.4 |
| 12.2 | 3800 | 0.9 | 1.1 | 1.1 | 1.1 | 1.2 | 1.2 | 1.2 | 1.2 |

### Example 13

The following samples were prepared and tested in the same manner as in Example 3. Results are shown in Table 13.

13.1 Polymer with 3% 1,3-dicyclohexylcarbodiimide, 10% zinc oxide at 70% solids, and 50% Cu₂O

TABLE 13
Viscosity Ratio (Relative to Initial Viscosity) per Time (Weeks)

| | Initial | | | | | | | | |
|---|---|---|---|---|---|---|---|---|---|
| ID# | Visc. | 1 | 2 | 3 | 4 | 5 | 6 | 7 | 8 |
| 13.1 | 1130 | 1.2 | 1.2 | 1.3 | 1.1 | 1.4 | 1.4 | 1.5 | 1.5 |

Conclusion: Dicyclohexyl carbodiimide is compatible with a worst-case formulation, 10% zinc oxide, and 50% Cu₂O.

### Example 14

The following samples were prepared and tested in the same manner as in Example 3. Results are shown in Table 14.
14.1 (Comparative) Polymer with 50% Cu₂O and 5% dimethylglycoxime.
14.2 (Comparative) Polymer with 50% Cu₂O and 5% pyridine n-oxide.
14.3 (Comparative) Polymer with 50% Cu₂O and 5% ethylenediamine tetracetic acid disodium salt dihydrate.
14.4 (Comparative) Polymer with 50% Cu₂O and 5% 4-t-butylcatechol.
14.5 Polymer with 50% Cu₂O and 5% 1,2,4-triazole.

14.6 Polymer with 50% Cu₂O and 5% benzotriazole.

TABLE 14
Viscosity Ratio (Relative to Initial Viscosity) per Time (Weeks)

| | Initial | | | | | | | | |
|---|---|---|---|---|---|---|---|---|---|
| ID# | Visc. | 1 | 2 | 3 | 4 | 5 | 6 | 7 | 8 |
| 14.1 | 4800 | * | * | * | * | * | * | * | * |
| 14.2 | 6800 | * | * | * | * | * | * | * | * |
| 14.3 | 7685 | 2.5 | 4.2 | * | * | * | * | * | * |
| 14.4 | 5560 | 3.2 | * | * | * | * | * | * | * |
| 14.5 | 6150 | 1.6 | 1.7 | 2.1 | 2.2 | 2.6 | 2.4 | 2.9 | 3.0 |
| 14.6 | 6475 | 1.3 | 1.4 | 1.4 | 1.8 | 1.9 | 2.1 | 1.9 | 2.3 |

Conclusion: Triazoles are also effective stabilizers.

### Example 15

The following samples were prepared and tested in the same manner as in Example 3. Results are shown in Table 15.
15.1 Polymer with 50% Cu₂O, 5% 1,3, dicyclohexylacrbodiimide and 5% ZnPT.
15.2 Polymer with 50% Cu₂O, 3% 1,3, dicyclohexylacrbodiimide and 5% ZnPT.

15.3 Polymer with 50% Cu₂O, 5% 1,3, dicyclohexylacrbodiimide, 5% ZnPT and 10% zinc oxide.

TABLE 15
Viscosity Ratio (Relative to Initial Viscosity) per Time (Weeks)

| ID# | Initial Visc | 1 | 2 | 3 | 4 | 5 | 6 | 7 | 8 |
|---|---|---|---|---|---|---|---|---|---|
| 15.1 | 6615 | 1.3 | 1.5 | 1.6 | 1.5 | 2.3 | 2.1 | 2.5 | 3.8 |
| 15.2 | 7740 | 1.2 | 1.3 | 1.5 | 1.4 | 2.0 | 1.6 | 2.0 | 2.7 |
| 15.3 | 8050 | 1.3 | 1.4 | 1.5 | 1.6 | 1.8 | 2.0 | 3.4 | 3.4 |

Conclusion: Dicyclohexyl carboiimide performs effectively in the presence of Cu₂O, ZnPT and ZnO

### Example 16

The following samples were prepared and tested in the same manner as in Example 3. Results are shown in Table 16.

16.1 Polymer with 3% 1,3, dicyclohexylacrbodiimide and 5% Sea Nine211from Rohm and Haas.

TABLE 16
Viscosity Ratio (Relative to Initial Viscosity) per Time (Weeks)

| ID# | Initial Visc. | 1 | 2 | 3 | 4 | 5 | 6 | 7 | 8 |
|---|---|---|---|---|---|---|---|---|---|
| 16.1 | 1076 | 0.8 | 1 | 0.9 | 1 | 0.9 | 1.0 | 1.0 | 1.1 |

Conclusion: Dicyclohexyl carbodiimide stabilized binder is compatible with SeaNine 211.

### Example 17

The following samples were prepared and tested in the same manner as in Example 3. Results are shown in Table 17.
17.1 Polymer with 50% Cu₂O, 10% zinc oxide, and 3% benzotriazole.
17.2 Polymer with 50% Cu₂O, 10% zinc oxide, and 3% 1,3-bis(trimethylsilyl) carbodiimide.
17.3 (Comparative) Polymer with 50% Cu₂O, 10% zinc oxid, and 3% 1,3-bis(trimethylsilyl) carbodiimide:HCl.
17.4 Polymer with 50% Cu₂O, 10% zinc oxide, and 3% diisopropyl carbodiimide.
17.5 Polymer with 50% Cu₂O, 10% zinc oxide, 3% diisopropyl carbodiimide and 3% zinc-omadine.
17.6 Polymer with 50% Cu₂O, 10% zinc oxide, 3% N-(3-dimethylamino-propyl)-N'-ethylcarbodiimide.

17.7 Polymer with 50% Cu₂O, 10% zinc oxide, and 3% 1-3 dicyclohexyl carbodiimide.

TABLE 17
Viscosity Ratio (Relative to Initial Viscosity) per Time (Weeks)

| | Initial | | | | | | | | |
|---|---|---|---|---|---|---|---|---|---|
| ID# | Visc | 1 | 2 | 3 | 4 | 5 | 6 | 7 | 8 |
| 17.1 | 9775 | 2.1 | 2.5 | 3.3 | 3.2 | 5.2 | 6.9 | 7.3 | 7.1 |
| 17.2 | 5565 | 1.2 | 1.2 | 1.2 | 5.7 | 1.2 | 1.5 | 1.4 | 1.3 |
| 17.3 | 11725 | * | * | * | * | * | * | * | * |
| 17.4 | 4975 | 1.6 | 1.4 | 1.7 | 1.8 | 2.0 | 2.1 | 2.3 | 2.5 |
| 17.5 | 6560 | 1.5 | 1.2 | 1.3 | 1.6 | 1.6 | 1.9 | 1.7 | 1.7 |
| 17.6 | 7815 | * | * | * | * | * | * | * | * |
| 17.7 | 9625 | 1.3 | 1.1 | 1.3 | 1.4 | 1.5 | 1.5 | 1.6 | 1.7 |

Conclusion: 1,3-bis(trimethylsilyl) carbodiimide, and diisopropyl carbodiimide are as effective as dicyclohexylcarbodlimide.

### Example 18

The following sample was prepared and tested in the same manner as in Example 3 with the exception that the accelerated stability test was carried out at 60° C. Result is shown in Table 18.

19.1 Polymer containing 3% 1,3-Dicyclohexycarbodiimide.

TABLE 18
Viscosity Ratio (Relative to initial Viscosity)

| ID# | Initial | 1 | 2 | 3 | 4 | 5 | 6 | 7 | 8 |
|---|---|---|---|---|---|---|---|---|---|
| 19.1 | 4250 | 0.9 | 1.0 | 1.0 | 1.1 | 1.2 | 1.2 | 1.1 | 1.1 |

Conclusion: The stabilizing effect of dicyclohexyl carbodiimide was confirmed at the higher temperature.

1. A stabilized binder composition for use in an anti-foulant coating comprising:
a) one or more hydrolyzable organic binders; and
b) 0.01 to 20 percent by weight, based on the binder solids, of one or more stabilizers selected from the group consisting of triorgano phosphites, triorgano amines, heteroaromatic nitrogen compounds, and carbodiimides.

2. The stabilized binder composition of claim 1 wherein said binder is a (meth)acrylic copolymer binder.

3. The stabilized binder composition of claim 2 wherein said acrylic copolymer binder is a silylacrylic binder.

4. The stabilized binder composition of claim 1 wherein said triorgano phosphites comprise triethylphosphite, tripropylphosphite, tributylphosphite, and mixtures thereof.

5. The stabilized binder composition of claim 1 wherein said triorgano amines comprise tripropyl amine.

6. The stabilized binder composition of claim 1 wherein said heteroaromatic nitrogen compounds comprise pyridine and pyridine derivatives.

7. The stabilized binder composition of claim 1 wherein said carbodiimides comprise dicyclohexylcarbodiimide.

8. The stabilized binder composition of claim 1 wherein said stabilizer comprises 0.1 to 8.0 percent by weight, based on the binder solids.

9. The stabilized binder composition of claim 1 comprising at least one triorgano phosphite and at least one triorganio amine and/or heteroaromatic nitrogen compound.

10. An antifoulant coating composition comprising:
a) one or more hydrolyzable organic binders;
b) 0.01 to 20 percent by weight, based on the binder solids, of one or more stabilizers selected from the group consisting of triorgano phosphites, triorgano amines, heteroaromatic nitrogen compounds, and carbodiimides; and
c) an anti-foulant.

11. The anti-foulant coating composition of claim 10, wherein said antifoulant comprises cuprous oxide, and organic booster biocide.

12. The anti-foulant coating composition of claim 10 further comprising one or more additives selected from the group consisting of co-binders, pigments, organic dyes, fillers, drying agents, thixotropic agents, plasticizers, dispersing agents, biocides, co-biocides and booster organic biocides.
